(19) United States
(12) Patent Application Publication
(10) Pub. No.: US 2010/0054478 A1
(43) Pub. Date: Mar. 4, 2010

(54) SECURITY ASSET MANAGEMENT SYSTEM

(76) Inventor: Raju Venkata Kolluru, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/202,799

(22) Filed: Sep. 2, 2008

(51) Int. Cl. H04L 9/08; H04L 9/32

(52) U.S. Cl. 380/278; 726/1

(57) ABSTRACT

Some example embodiments described herein relate a security asset management system and a computerized method. The security asset management system includes a first server that is need of a security asset and a second server that provides the needed security asset to the first server. The second server is adapted to manage security assets. In some embodiments, the second server classifies the security assets as public and private security assets. In some embodiments, the second server may automatically rotate the security assets that it manages. In some embodiments, the computerized method includes connecting a first server to a second server that is adapted to manage security assets. The computerized method further includes detecting that the first server is in need of a security assets and using the second server to provide the needed security asset to the first server.

### TECHNICAL FIELD

Example embodiments relate generally to the technical field of managing security assets that are used in on-line commerce.

### BACKGROUND

The Internet and the World Wide Web (“Web”) have changed the landscape of information delivery and affected numerous aspects of life. One area that has benefited from this technological development is the ability for individuals to buy and sell products over the Internet (i.e., electronic commerce).

A number of technical challenges exist with respect to authorization and authentication of users and/or systems that engage in electronic commerce. As an example, when a user accesses a primary system via a secondary system, there is often a great deal of sensitive information that is transmitted between the primary and secondary systems.

A key management system is typically used to manage the keys that are utilized to ensure the safe exchange of information between the primary and secondary systems. Existing security asset management systems typically include one or more different types of keys such as PrivateKey, X.509Certificate, SharedKey, or non-key security assets such as passphrases or rounds of encryption. One drawback with existing security asset management systems is that there is no good system for managing all of the different types of security assets, especially those security asset management systems that include non-key security assets.

Security asset management involves the secure generation, distribution, revocation, storage, audit, rotation and access control of security assets. Most attacks on security systems are aimed at key management and key usage level as opposed to the cryptographic algorithm within such systems.

### BRIEF DESCRIPTION OF THE DRAWINGS

Some example embodiments are illustrated by way of example and not limitation in the figures of the accompanying drawings in which:

FIG. 1 is a block diagram illustrating an example embodiment of a security asset management system;

FIG. 2 is a flow diagram illustrating an example embodiment of a computerized method that utilizes the security asset management system shown in FIG. 1;

FIG. 3 is a block diagram illustrating an example embodiment of a network-based system that utilizes the security asset management system shown in FIG. 1; and

FIG. 4 is a block diagram illustrating a diagrammatic representation of a machine in the example form of a computer system.

### DETAILED DESCRIPTION

Example methods and security asset management systems are described herein. In the following description, for purposes of explanation, numerous specific details are set forth to provide a thorough understanding of example embodiments. It will be evident, however, to one skilled in the art that embodiments of the present invention may be practiced without these specific details.

The security assets management system (SAMS) and method described herein provide a comprehensive solution for security asset management. The SAMS is a secure, centrally administered security asset management system that is designed to simplify the deployment and usage of security assets in an on-line commerce site. A security asset may be a piece of security information that the application uses for any security operation (e.g., encryption, signature).

In some embodiments, a security asset may or may not be a secret. Some example secret security assets are PrivateKey, SharedKey and passphrase. Some examples of non-secret (or publicly available) security assets are InitializationVector (IV), PublicKey, and Certificate etc.

In some embodiments, a security asset may or may not be a Key. Some examples of non-key security assets include InitializationVector (IV), SignedDocument or passphrase. The SAMS handles multiple different types of security assets and provides a potentially robust, scalable, extensible and secure solution for managing security assets.

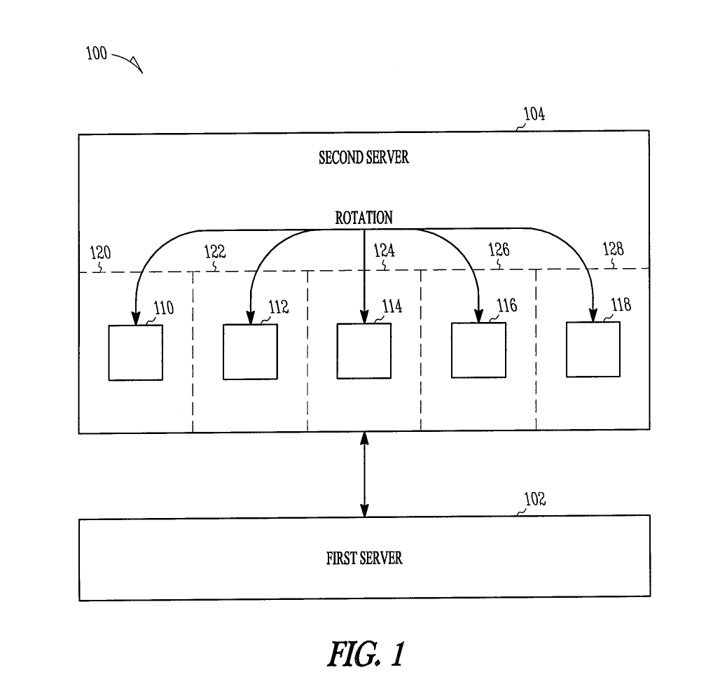

FIG. 1 is a block diagram illustrating an example embodiment of a SAMS 100. The SAMS 100 includes a first server 102 that is need of a security asset and a second server 104 that provides the security assets 110, 112, 114, 116, 118 to the first server 102. The second server 104 is adapted to manage all types of security assets. In some embodiments, the second server 104 classifies the security assets as public and private security assets.

In some embodiments, the second server 104 may provide secret and/or non-secret security assets to the first server 102. As an example, the second server 104 may provide keyed security assets (e.g., shared key security assets, private key security assets, digital certificates and/or public key security assets).

The second server 104 may also provide non-keyed secret security assets to the first server 102. Examples of non-keyed secret security assets include digitally signed documents, passphrases and/or passwords. In some embodiments, the non-keyed secret security asset may be a number that tells the first server 102 how many times to encrypt clear data.

It should be noted that the second server 104 may automatically rotate the security assets 110, 112, 114, 116, 118 that it manages. The SAMS 100 may automatically rotate the security assets 110, 112, 114, 116, 118 that it manages based on a rotation a policy that is defined by the second server 104. In some embodiments, “rotating” security assets means changing between different types of security assets while in other embodiments “rotating” security assets refers to replacing the same type of security assets. As an example, the second server 104 may automatically rotate the security assets 110, 112, 114, 116, 118 that do not have an expiry.

In some embodiments, the second server 104 manages the lifecycle (i.e., life span) of security assets 110, 112, 114, 116, 118. The lifecycle of security assets 110, 112, 114, 116, 118 may be managed by using policy-based key generation, retrieval, automated expiration, caching, archiving, restoring and audit logging.

All objects that are stored with in the SAMS 100 are digitally signed and encrypted. The encryption of the objects promotes confidentiality while digitally signing the object prevents tampering with the objects. It should be noted that the SAMS may facilitate the centralized administration of on-line security operations such as creating new security assets, labeling existing security assets or granting or revoking existing security assets.

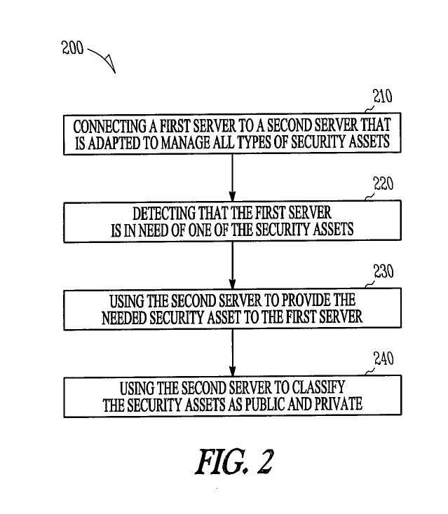

FIG. 2 is a flow diagram illustrating an example embodiment of a computerized method 200 that utilizes the SAMS 100 shown in FIG. 1. The computerized method 200 includes the operation 210 of connecting a first server 102 to a second server 104 that is adapted to manage all types of security assets (e.g., keyed and/or non-keyed, public and/or private, secret and/or non-secret). The computerized method 200 further includes the operation 220 of detecting that the first server 102 is in need of one of the security assets and the operation 230 of using the second server 104 to provide the needed security asset to the first server 102. It should be noted that the operation 220 may be performed automatically by the SAMS 100 or manually by a system administrator that monitors the SAMS 100.

In some embodiments, the computerized method 200 may further include the operation 240 of using the second server 104 to classify the various types of security assets as public or private. This classification of security assets as public or private may be done by the SAMS administrator. In addition, classifying security assets as public or private allows the SAMS 100 to enable access control to the security assets.

In some embodiments, using the second server 104 to provide the needed security asset to the first server 102 may include using the second server to provide public and private security assets. In addition, using the second server 104 to provide the needed security asset to the first server 102 may include using the second server 104 to provide a keyed security asset (e.g., a shared key security asset, a private key security asset, a digital certificate and/or a public key security asset.

It should be noted that using the second server 104 to provide the needed security asset to the first server 102 may include using the second server 102 to provide non-keyed secret security assets. As an example, using the second server 104 to provide non-keyed secret security assets may include instructing the first server 102 as to how many times to encrypt clear data.

In some embodiments, using the second server 104 to provide the needed security asset to the first server 102 includes automatically rotating between the security assets that the second server 104 manages (e.g. by automatically rotating the security assets that the second server 104 manages based on a rotation a policy that is defined by the second server 104). It should be noted that automatically rotating between the security assets that the second server 104 manages may include automatically rotating the security assets that do not have an expiry.

Connecting a first server 102 to a second server 104 may include connecting the first server 102 to a second server 104 that includes security assets 110, 112, 114, 116, 118 which are stored within different security zones 120, 122, 124, 126, 128 such that the second server 104 manages security assets 110, 112, 114, 116, 118 that are within the different security zones 120, 122, 124, 126, 128. The different security zones 120, 122, 124, 126, 128 may have different levels of access control. As an example, one or more of the zones may protect the security assets within those security zones by using a firewall or some form of authentication and/or authorization.

In the example embodiment that is shown in FIG. 1, security assets 110, 112, 114, 116, 118 are located within different security zones 120, 122, 124, 126, 128. It should be noted that in some embodiments, a security zone may include more than one security asset.

In some embodiments, the computerized method 200 allows a SAMS 100 to implement a security asset rotation policy. The security asset rotation policy may be automatic and/or explicit depending on the security protocols that are desired within a SAMS 100.

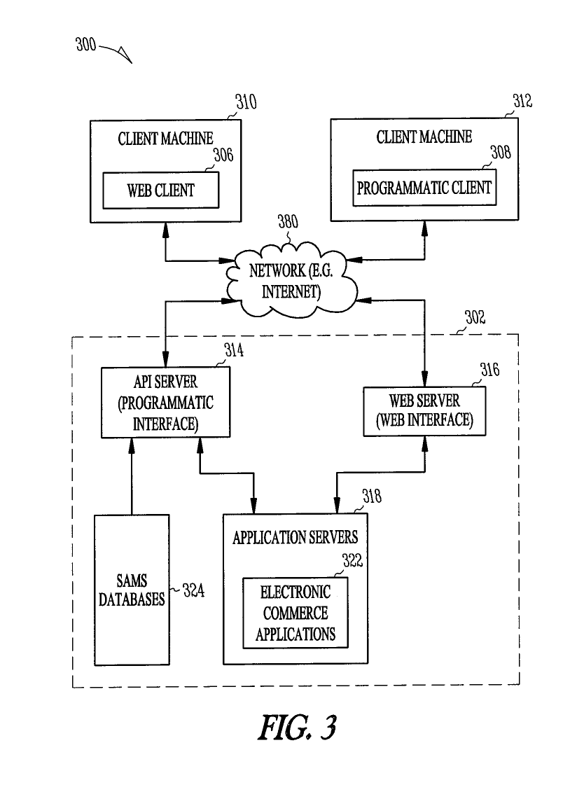

FIG. 3 is a block diagram illustrating an example embodiment of a network-based system 300 having a client-server architecture for utilizing an electronic commerce system 302. The network-based electronic commerce system 302 provides server-side functionality, via a network 380 (e.g., the Internet) to one or more clients. In the illustrated example embodiment, a Web client 306 (e.g., a browser, such as the INTERNET EXPLORER browser developed by MICROSOFT CORPORATION of Redmond, Wash.), and a programmatic client 308 are executed on respective client machines 310 and 312.

An Application Program Interface (API) server 314 and a Web server 316 are coupled to, and provide programmatic and Web interfaces respectively to, one or more application servers 318. The API server 314 is connected to one or more client machines 310, 312 as described above in order to promote secure transactions between Web server 316 and client machines 310, 312.

In some example embodiments, the API server 314 may be similar to the first server 102 as described with reference to FIG. 1 and Web server 316 may be similar to the second server 104 as described with reference to FIG. 1. In addition, the API server 314 may be connected to one or more SAMS databases 324 in order to promote secure transactions between Web server 316 and API server 314.

The application servers 318 host one or more electronic commerce applications 322. The electronic commerce applications 322 may facilitate real-time contextual in person-to-person electronic commerce activities over the network 380.

Further, while the network-based payment system 300 shown in FIG. 3 employs a client-server architecture, the present application is of course not limited to such an architecture and could equally well find application in a distributed, or peer-to-peer, architecture system. The various electronic commerce applications 322 may also be implemented as standalone software programs, which do not necessarily have networking capabilities.

It should be appreciated that the Web client 306 may access the various electronic commerce applications 322 via the Web interface supported by the Web server 316. Similarly, the programmatic client 308 may access the various electronic commerce functions provided by the electronic commerce applications 322 via the programmatic interface provided by the API server 314.

### Example Machine Architecture

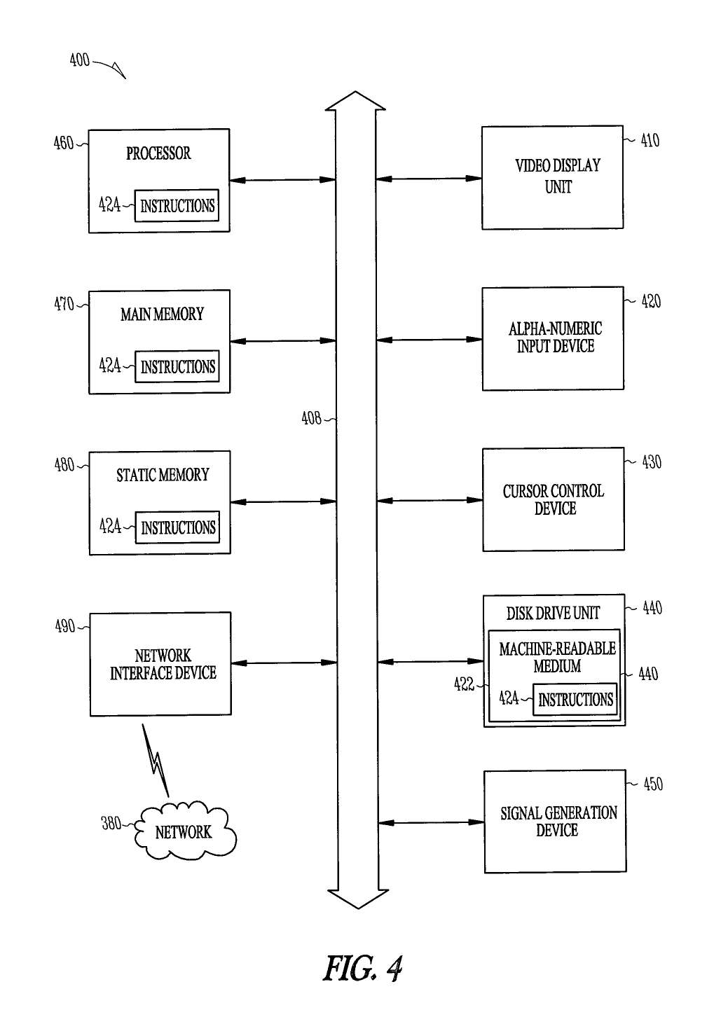

FIG. 4 is a block diagram that illustrates a diagrammatic representation of a machine in the example form of a computer system 400 within which a set of instructions for causing the machine to perform any one or more of the methodologies discussed herein may be executed. In some embodiments, the servers which are illustrated in FIGS. 1 and 3 may be partially or wholly incorporated into any portion of the computer system 400.

In alternative embodiments, the computer system 400 may operate as a standalone device or may be connected (e.g., networked) to other machines. In a networked environment, the computer system 400 may operate in the capacity of a server or a client machine in a server-client network environment, or as a peer machine in a peer-to-peer (or distributed) network environment.

The computer system 400 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 may include a processor 460 (e.g., a central processing unit (CPU), a graphics processing unit (GPU) or both), a main memory 470 and a static memory 480, all of which communicate with each other via a bus 408. The computer system 400 may further include a video display unit 410 (e.g., liquid crystal displays (LCD) or cathode ray tube (CRT)). The computer system 400 also may include an alphanumeric input device 420 (e.g., a keyboard), a cursor control device 430 (e.g., a mouse), a disk drive unit 440, a signal generation device 450 (e.g., a speaker), and a network interface device 490.

The disk drive unit 440 may include a machine-readable medium 422 on which is stored one or more sets of instructions (e.g., software 424) embodying any one or more of the methodologies or functions described herein. The software 424 may also reside, completely or at least partially, within the main memory 470 and/or within the processor 460 during execution thereof by the computer system 400, the main memory 470 and the processor 460 also constituting machine-readable media. It should be noted that the software 424 may further be transmitted or received over a network (e.g., network 380 in FIG. 3) via the network interface device 490.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of example embodiments described herein. The term “machine-readable medium” shall accordingly be taken to include, but not be limited to, solid-state memories and optical and magnetic media.

Thus, a computerized method and security asset management system is described herein. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computerized method comprising:
connecting a first server to a second server that is adapted to manage security assets;
detecting that the first server is in need of a security assets; and
using the second server to provide the needed security asset to the first server.

2. The computerized method of claim 1, wherein using the second server to provide the needed security asset to the first server includes using the second server to provide secret and non-secret security assets.

3. The computerized method of claim 1, wherein using the second server to provide the needed security asset to the first server includes using the second server to provide a keyed security asset.

4. The computerized method of claim 3, wherein using the second server to provide a keyed security asset further includes using the second server to provide a shared key security asset.

5. The computerized method of claim 3, wherein using the second server to provide a keyed security asset includes using the second server to provide a private key security asset.

6. The computerized method of claim 3, wherein using the second server to provide a keyed security asset includes using the second server to provide a digital certificate.

7. The computerized method of claim 3, wherein using the second server to provide a keyed security asset includes using the second server to provide a public key security asset.

8. The computerized method of claim 1, wherein using the second server to provide the needed security asset to the first server includes using the second server to provide non-keyed secret security assets.

9. The computerized method of claim 8, wherein using the second server to provide non-keyed secret security assets includes using the second server to provide a password to the first server.

10. The computerized method of claim 8, wherein using the second server to provide non-keyed secret security assets includes instructing the first server as to how many times to encrypt clear data.

11. The computerized method of claim 1, wherein using the second server to provide the needed security asset to the first server includes automatically rotating between the security assets that the second server manages.

12. The computerized method of claim 11, wherein automatically rotating between the security assets that the second server manages includes automatically rotating the security assets that the second server manages based on a rotation a policy that is defined by the second server.

13. The computerized method of claim 11, wherein automatically rotating between the security assets that the second server manages includes automatically rotating the security assets that do not have an expiry.

14. The computerized method of claim 1, further comprising using the second server to classify the security assets as public or private.

15. The computerized method of claim 1, wherein connecting a first server to a second server that is adapted to manage security assets includes connecting the first server to a second server that includes security assets which are stored within different security zones such that the second server manages security assets that are within the different security zones.

16. A security asset management system comprising:
a first server that is need of a security asset; and
a second server that provides a needed security asset to the first server, the second server being adapted to manage multiple security assets.

17. The system of claim 16, wherein the needed security asset provided by the second server includes secret security assets.

18. The system of claim 16 wherein the needed security asset provided by the second server includes a keyed security asset.

19. The system of claim 18 wherein the keyed security asset is a shared key security asset.

20. The system of claim 18, wherein the keyed security asset is a private key security asset.

21. The system of claim 18, wherein the keyed security asset is a digital certificate.

22. The system of claim 18, wherein the keyed security asset is a public key security asset.

23. The system of claim 16, wherein the needed security asset provided by the second server includes non-keyed secret security assets.

24. The system of claim 23, wherein the non-keyed secret security asset is a number that tells the first server how many times to encrypt clear data.

25. The system of claim 23 wherein the non-keyed secret security asset is a digitally signed document.

26. The system of claim 23, wherein the non-keyed secret security asset is a passphrase.

27. The system of claim 23, wherein the non-keyed secret security asset is a password.

28. The system of claim 16, wherein the second server automatically rotates the security assets that it manages.

29. The system of claim 28, wherein the second server automatically rotates the security assets that it manages based on a rotation policy that is defined by the second server.

30. The system of claim 28, wherein the second server automatically rotates the security assets that do not have an expiry.

31. The system of claim 16, wherein the second server classifies the security assets as public and private.

32. The system of claim 16, wherein the second server includes security assets that are stored within different security zones and wherein the second server manages security assets that are stored within the different security zones.

33. A machine-readable medium comprising instructions, which when implemented by one or more processors perform the following operations:
connecting a first server to a second server that is adapted to manage security assets;
detecting that the first server is in need of one of a security asset; and
using the second server to provide the needed security asset to the first server.

34. The machine-readable medium of claim 33 wherein using the second server to provide the needed security asset to the first server includes using the second server to provide secret and non-secret security assets.

35. The machine-readable medium of claim 33 wherein using the second server to provide the needed security asset to the first server includes using the second server to provide a keyed security asset.

36. The machine-readable medium of claim 33 wherein using the second server to provide the needed security asset to the first server includes automatically rotating between the security assets that the second server manages.

37. The machine-readable medium of claim 33 wherein connecting a first server to a second server that is adapted to manage all types of security assets includes connecting the first server to a second server that includes security assets which are stored within different security zones such that the second server manages security assets that are within the different security zones.

38. The machine-readable medium of claim 33 further comprising instructions which when implemented by one or more processors further perform the following operations:
using the second server to classify the security assets as public or private.
